(19) United States
(12) Patent Application Publication
(10) Pub. No.: US 2026/0057611 A1
(43) Pub. Date: Feb. 26, 2026

(54) SPECIES DISTRIBUTION DATA AGGREGATION METHOD AND SYSTEM, AND STORAGE MEDIUM

(71) Applicant: Hangzhou Ruisheng Software Co., Ltd., Zhejiang (CN)

(72) Inventors: Qingsong Xu, Zhejiang (CN); Qing Li, Zhejiang (CN)

(73) Assignee: Hangzhou Ruisheng Software Co., Ltd., Zhejiang (CN)

(21) Appl. No.: 19/104,706

(22) PCT Filed: Jul. 20, 2023
(86) PCT No.: PCT/CN2023/108385

§ 371 Date: Feb. 19, 2025

(30) Foreign Application Priority Data
Aug. 23, 2022 (CN) 202211014905.5

(51) Int. Cl. G06T 17/05; G06F 16/29; G06F 16/906

(52) U.S. Cl. CPC G06T 17/05; G06F 16/29; G06F 16/906

(57) ABSTRACT

The present invention provides a species distribution data aggregation method and system, and a storage medium. The method comprises: obtaining original species distribution data; determining a map grid scale displaying the species distribution, and acquiring the original species distribution data within a range of each grid; and taking each grid as a central grid, and performing data enhancement on the central grid by using original species distribution data of multiple other grids within a set range around each grid, thereby obtaining a species distribution data aggregation result of each grid. The species distribution data aggregation method provided by the invention can enhance the display of the species distribution data, thereby improving the data display effects.

### FIELD OF THE DISCLOSURE

This disclosure relates to the field of computer technology, particularly to a species distribution data aggregation method and system, and a storage medium.

### DESCRIPTION OF RELATED ART

The distribution of each species across various locations globally is inconsistent, with each locality exhibiting distinct prevalent species. A species database that provides lists of common species based on geographical location may be established, while also accommodating users'personalized information requirements. However, the distribution of data obtained from species observations is uneven, and the number of species within a range is generally not substantial, resulting in poor display effects. Therefore, it is necessary to enhance the data to a certain extent.

### SUMMARY OF THE DISCLOSURE

One purpose of this disclosure is to provide a species distribution data aggregation method, including the following steps:
obtaining original species distribution data;
determining a map grid scale displaying the species distribution, and acquiring the original species distribution data within the range of each grid; and
taking each grid as a central grid, and performing data enhancement on the central grid by using original species distribution data of multiple other grids within a set range around each grid, thereby obtaining a species distribution data aggregation result of each grid.

In some embodiments, the original species distribution data may be obtained through a species distribution data source and species identification result information.

In some embodiments, obtaining the original species distribution data through species identification result information includes: obtaining user wireless data or mobile data for processing to obtain the original species distribution data.

In some embodiments, the method further includes: after obtaining the original species distribution data within the range of each grid, processing the original species distribution data according to species commonness to obtain processed species distribution data, and utilizing the processed species distribution data for subsequent data enhancement.

In some embodiments, the method further includes: obtaining an elevation value for each grid, calculating the elevation difference between each central grid and multiple other grids within the set range around the grid, wherein when the elevation difference between any one of the multiple other grids and the central grid thereof is greater than a set threshold, the original species distribution data of the multiple other grids do not involve in the data enhancement of the central grid.

In some embodiments, the set threshold of the elevation difference is separately set and adjusted according to different regions.

In some embodiments, the map grid scale is separately set and adjusted according to different regions and/or different map grid scales are set for the same region.

In some embodiments, the data enhancement includes: obtaining a weight value for each of the other grids within the set range around the central grid according to a set attenuation coefficient, multiplying the original species distribution data of the other grids by the weight value and added to the data of the central grid, thus finally obtaining the species distribution data aggregation result after data enhancement for the central grid.

In some embodiments, the attenuation coefficient is separately set and adjusted according to different regions.

In some embodiments, the method further includes: classifying the original species distribution data according to the time dimension, obtaining original species distribution data within the range of each grid at different times, and performing data enhancement separately based on the original species distribution data at different times.

According to another aspect of this disclosure, a species distribution data aggregation system is provided, including a processor and a memory. The memory stores a program. When the program is executed by the processor, the species distribution data aggregation method as described above is realized.

According to another aspect of this disclosure, a storage medium is provided, which stores a program. When the program is executed, the species distribution data aggregation method as described above is realized.

Through the following detailed description of exemplary embodiments of the present disclosure with reference to the accompanying drawings, other features and advantages of the present disclosure will become more apparent.

### BRIEF DESCRIPTION OF THE DRAWINGS

The accompanying drawings, which form a part of this specification, illustrate embodiments of this disclosure and, together with the specification, serve to explain the principles of this disclosure.

With reference to the accompanying drawings, this disclosure may be more clearly understood according to the following detailed description, wherein:

FIG. 1 shows a flow chart of a species distribution data aggregation method provided by an embodiment of this disclosure.

FIG. 2 shows a schematic diagram of weight values for each of other grids within a set range around a central grid, as provided by an embodiment of this disclosure.

FIG. 3 shows a schematic diagram of weight values for each of other grids within a set range around a central grid, as provided by another embodiment of this disclosure.

FIG. 4 shows a schematic diagram of a species distribution data aggregation result for a region, as provided by an embodiment of this disclosure.

FIG. 5 shows a structural diagram of a species distribution data aggregation system provided by an embodiment of this disclosure.

Note that in the embodiments described below, the same reference numerals are sometimes used across different drawings to indicate the same parts or parts with the same function, and repeated descriptions of the same reference numerals are omitted. In some cases, similar numbers and letters are used to indicate similar items, so once an item is defined in one drawing, it does not need to be further discussed in subsequent drawings.

For ease of understanding, the positions, dimensions, and ranges of various structures shown in the drawings and elsewhere may not represent actual positions, dimensions, and ranges. Therefore, this disclosure is not limited to the positions, dimensions, and ranges disclosed in the drawings and elsewhere.

### DESCRIPTION OF EMBODIMENTS

The various exemplary embodiments of this disclosure will be described in detail below with reference to the accompanying drawings. It should be noted that unless otherwise specifically stated, the relative arrangement of components and steps, numerical expressions, and numerical values set forth in these embodiments do not limit the scope of this disclosure.

The following description of at least one exemplary embodiment is actually only illustrative and is not intended as any limitation on this disclosure and its application or use. That is to say, the structures and methods in this document are shown in an exemplary manner to illustrate different embodiments of the structures and methods in this disclosure. However, those skilled in the art will understand that they merely illustrate exemplary ways that may be used to implement this disclosure, rather than exhaustive ways. Furthermore, the drawings need not be drawn to scale, and some features may be enlarged to show details of specific components.

For technologies, methods, and devices already known to ordinary skilled persons in the related field, detailed discussions may not be provided, but in appropriate circumstances, said technologies, methods, and devices should be considered as part of the authorized specification.

In all examples shown and discussed here, any specific values should be interpreted as merely exemplary and not as limitations. Therefore, other examples of exemplary embodiments may have different values.

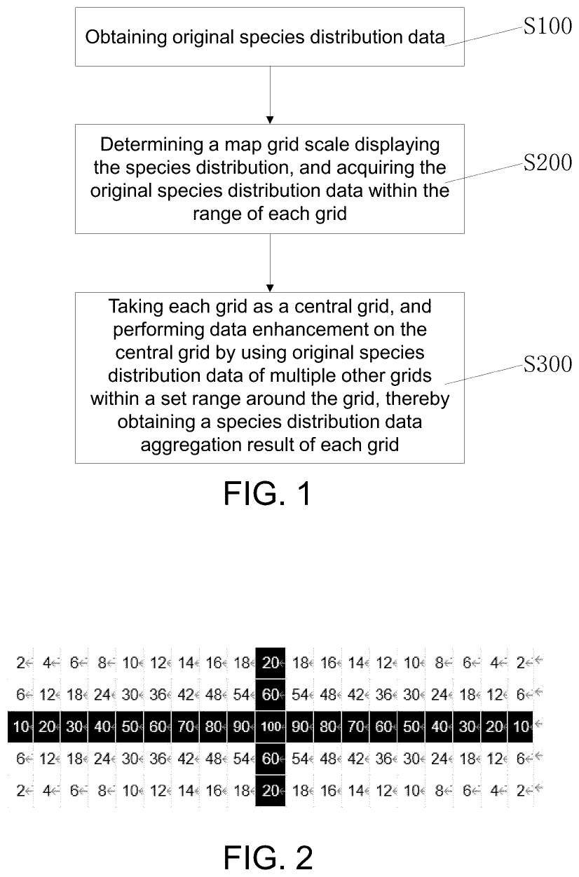

FIG. 1 shows a flow chart of a species distribution data aggregation method provided by an embodiment of this disclosure. This method may be implemented in an application (app) installed on smart terminals such as mobile phones, tablet computers, etc. As shown in FIG. 1, the method includes:
step S100: obtaining original species distribution data;
step S200: determining a map grid scale displaying the species distribution, and acquiring the original species distribution data within the range of each grid;
step S300: taking each grid as a central grid, and performing data enhancement on the central grid by using original species distribution data of multiple other grids within a set range around each grid, thereby obtaining a species distribution data aggregation result of each grid.

In some embodiments, the original species distribution data is obtained through a species distribution data source and species identification result information. The original species distribution data may be obtained through a species distribution data source, for example, through various publicly available general species distribution databases (such as GBIF: Global Biodiversity Information Facility) to obtain original species distribution data. These types of data sources contain a large amount of field observation data, which may serve as a data source for field species distribution.

In some embodiments, obtaining the original species distribution data through species identification result information includes: obtaining user wireless data or mobile data for processing to obtain the original species distribution data. For data from users identifying species through species identification software, the location information of species distribution may be obtained by processing and fitting the IP data of the user's wireless WiFi, which may serve as a reference for species data distribution information in specific regions such as residential regions or commercial and industrial regions. Meanwhile, in regions without wireless signals like WiFi, the approximate range of species distribution regions may also be determined by processing the user's mobile data (such as 3G, 4G or 5G), although it is difficult to determine the exact location of species distribution through such approach. The species identification software may identify plant species based on images captured by users, and present the classification information and other relevant information of the identified species based on the recognized species.

In some embodiments, the method further includes: after obtaining the original species distribution data within the range of each grid, processing the original species distribution data according to species commonness to obtain processed species distribution data, and utilizing the processed species distribution data for subsequent data enhancement.

Different species may be classified according to the degree of commonness, and species commonness may be displayed as extended information for subsequent display of species information. Additionally, users may choose to display only species distribution data of specific commonness levels or above a specific level. Species commonness may be statistically confirmed and correspondingly displayed based on the data of species location information within different regions and scale ranges. Species commonness may be determined in the following way. First, it is ensured that the species in the species list are included in the species inventory for this country (state) or other regional scope. Rare substances and protected species (e.g., IUCN species) shall by default be designated as uncommon. The commonness of horticultural species needs to be determined based on data. Data from species distribution data sources (such as GBIF data) serve as a reference for the commonness of wild species, and are statistically analyzed according to a set regional scale range (e.g., a 40*20 km grid). Species data, such as WiFi wireless data or mobile data, identified by users serve as a reference for the commonness of ornamental plants and may complement GBIF data. This may also be statistically analyzed according to a set regional scale range (e.g., a 40*20 km grid).

In some embodiments, the method further includes: obtaining an elevation value for each grid, calculating the elevation difference between each central grid and multiple other grids within the set range around the grid, wherein when the elevation difference between any one of the multiple other grids and the central grid thereof is greater than a set threshold, the original species distribution data of the multiple other grids do not involve in the data enhancement of the central grid.

Species observation data reflect that the distribution of species is uneven. If a species is common in a specific region, there should also be a distribution of the same species in its surrounding regions. In the meantime, the difference in elevation also has an impact on the regional range of species distribution. Additionally, the number of species within a grid range (e.g., 40*20 km) of a set scale is generally not very large, resulting in poor display effects. Therefore, it is necessary to enhance the data to a certain degree.

Within an elevation difference of 1000 meters (of course, the impact of elevation may also be disregarded), the observed species distribution data within the range of each grid need to expand to surrounding grids (i.e., the distance of weight attenuation for species distribution data). For example, the weight value may be set to gradually attenuate within 400 kilometers along the same latitude, and gradually attenuate within 100 kilometers along the same longitude. If the elevation difference is greater than 1000 meters, the expansion may not continue, because the species distribution in different regions with large elevation differences will also be significantly different.

In some embodiments, the set threshold of the elevation difference may be separately set and adjusted according to different regions, such as different ranges of 1500 meters, 2000 meters, etc. The threshold may be set consistently to different values, or different values may be set separately according to the different species distribution situations in different regions.

In some embodiments, the map grid scale is separately set and adjusted according to different regions and/or different map grid scales are set for the same region. For example, the map grid scale may be set to different scale ranges such as 40*20 km or 50*50 km. Different regions may be adopted to determine different display grid scales based on the species distribution data, and users may also choose to display different grid scales. In other words, data of a 50 km*50 km grid may be displayed by default, users may choose to reduce to a 40*20 grid, or the default may be a 40*20 grid or a 50*50 grid that remains unchanged.

Similarly, the elevation values for distribution and the distance of weight attenuation may also be set according to the species distribution situations in different regions as the degree of species distribution aggregation varies in different regions. For example, species distribution is less in desert, wilderness, or Gobi regions, while species distribution is more abundant in temperate or tropical rainforest regions. Therefore, different data may be set to conduct data enhancement in order to improve data display effects. The same reason applies to the impact of elevation and the distance of weight attenuation.

In some embodiments, the data enhancement includes: obtaining a weight value for each of the other grids within the set range around the central grid according to a set attenuation coefficient, multiplying the original species distribution data of the other grids by the weight value and added to the data of the central grid, thus finally obtaining the species distribution data aggregation result after data enhancement for the central grid.

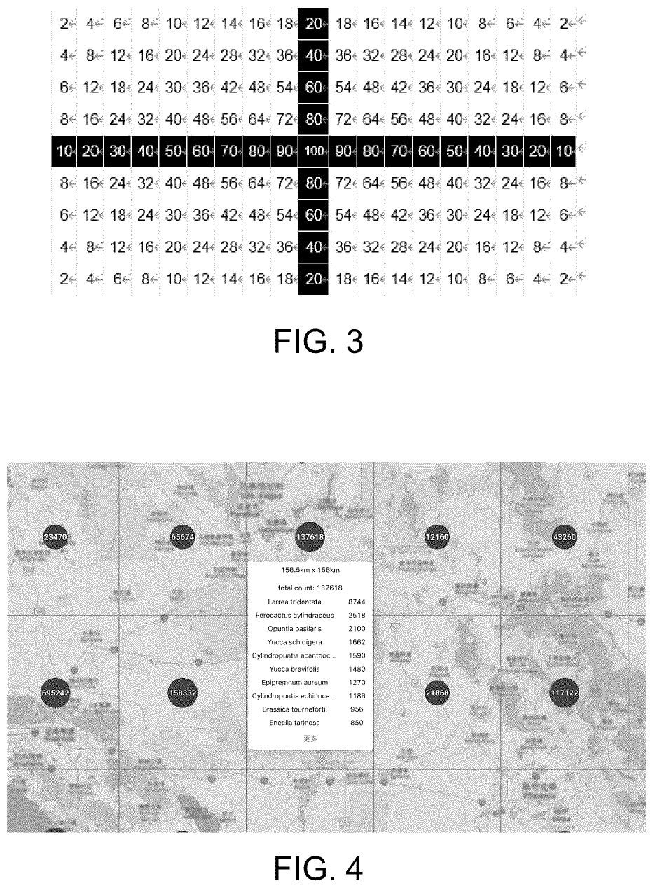

Furthermore, the attenuation coefficient is separately set and adjusted according to different regions. Please refer to FIG. 2 and FIG. 3, which show schematic diagrams of the weight values for each of other grids within the set range around a central grid provided by different embodiments. As shown in FIG. 2 and FIG. 3, the original weight value of the central grid is set to 100 (i.e., data in the central grid participates in the cumulative calculation at 100%), and other surrounding grids are calculated with attenuation according to the weight values set in the figure (90 means 90% participation in accumulation calculation, 60 means 60% participation in accumulation calculation). Finally, the data of the central grid is obtained by accumulating the result of multiplying the data of each grid within the set range around the grid multiplied by the percentage of the weight value.

FIG. 4 shows a schematic diagram of a species distribution data aggregation result for a region, as provided by an embodiment of this disclosure. When finally displaying species data in a 156.5*156km grid, the data displayed in each grid is the species data processed as described above. The species data may be displayed in an overall manner, and data of various classified species may be sorted and displayed overall by quantity. After loading the map, species distribution data is displayed on the map grid with an appropriate grid scale range according to grid data, as shown in FIG. 4. Corresponding to user operations, for example, when a user moves or clicks on a specific grid, the species distribution data corresponding to that grid is displayed.

In some embodiments, the method further includes: classifying the original species distribution data according to the time dimension, obtaining original species distribution data within the range of each grid at different times, and performing data enhancement separately based on the original species distribution data at different times.

Data may be divided according to time, such as by month, thereby modeling species distribution data as a three-dimensional coordinate of w*h*t, for example: m50-j12-w13-t4 represents the aggregation data for April, with 50 km as the geographic scale, the 12th in the longitude direction, the 13th in the latitude direction, and time divided by month. The relevant species distribution aggregation data is stored under this key. After adding the time dimension, more abundant and detailed species distribution data display ways may be defined, such as displaying species distribution data for a specific time period or for all time periods. The location information of species is recorded according to the actual latitude and longitude distribution range or specific location information, so that data statistics may be conducted under different grid scales and subsequently displayed separately according to requirements.

In addition, the aggregation data of species distribution for cities, provinces, or countries may also be displayed through calculation based on species distribution coordinates.

Main city data aggregation:
Provide lists of cities
Calculate aggregation data for each city
Obtain coordinates of the city
Invoke the above species distribution data
Obtain species distribution data for the city

Main province data aggregation:
Provide lists of provinces
Obtain lists of cities of the province, and aggregation data for each city
Aggregate the aggregation data of cities

Main country data aggregation
Provide lists of countries
Obtain lists of provinces of the country, and aggregation data for each province
Aggregate the aggregation data of provinces

Basic city data service
Obtain city/province/country according to latitude and longitude
Obtain lists of provinces of the country
Obtain lists of cities of the province
Obtain basic information of the city according to city code

The following ways are adopted to obtain user species information and update species distribution data aggregation database:
1. The user authorizes geographic location, or the latitude and longitude of the user's location may be inferred according to the user's IP information.
2. The latitude and longitude encoding information of geographic location algorithm (Geohash) of the user's location is calculated according to the latitude and longitude, and matched to the geographic grid database.
3. The data of this grid is obtained.
4. The geographic grid data and user dynamic information (plants photographed, current time, etc.) are combined to provide suggestions and information that fit the local environment for the user.

The geographic location algorithm Geohash is a way to divide the entire Earth into user grids, such as dividing the entire Earth into 40 km*20 km grid blocks, and then any latitude and longitude coordinates can be quickly located to these grids. We may store local relevant information in the Geohash grid blocks, including storing a list of common local plants according to the species distribution database, and storing local meteorological information according to the meteorological and climate information basic database:
a. Daily minimum temperature, maximum temperature, average temperature
b. Monthly average temperature
c. Precipitation information, at least including monthly average precipitation
d. Humidity information, at least including monthly average humidity
e. Light exposure information
f. Hardiness zone information

Other information may include common species information, elevation and other topographical information, climate zone classification information, vegetation information, and other related information. Different species datasets and species distribution data are associated and stored together to facilitate various interactive displays and functional processing after the species distribution data is aggregated and displayed. For example, it is possible to obtain a list of common species near a geographic location, and climate/meteorological information of species distribution regions according to the geographical location, and at the same time meet users'personalized information needs, such as viewing common poisonous plants near New York, common weeds near Los Angeles, and aggregation information on common fish species at various fishing spots.

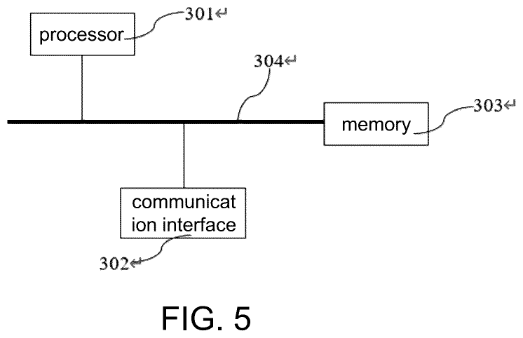

Based on the same inventive concept, this disclosure further provides a species distribution data aggregation system, including a processor and a memory. The memory stores a program. When the program is executed by the processor, the species distribution data aggregation method as described above is realized. Please refer to FIG. 5, which shows a structural diagram of a species distribution data aggregation system provided by an embodiment of this disclosure. As shown in FIG. 5, the species distribution data aggregation system includes a processor 301, a communication interface 302, a memory 303, and a communication bus 304.

The processor 301, the communication interface 302, and the memory 303 complete communication with each other through the communication bus 304.

The memory 303 is configured to store computer programs.

The processor 301 is configured to execute the program stored in the memory 303 to implement the following steps:
obtaining original species distribution data;
determining a map grid scale displaying the species distribution, and acquiring the original species distribution data within the range of each grid;
taking each grid as a central grid, and performing data enhancement on the central grid by using original species distribution data of multiple other grids within a set range around the grid, thereby obtaining a species distribution data aggregation result of each grid.

Regarding the specific implementation of each step of this method and related explanatory content, reference may be made to the implementation shown in FIG. 1 above, which will not be repeated here.

In addition, other implementation of the species distribution data aggregation method realized by the processor 301 executing the program stored in the memory 303 are the same as the implementation mentioned in the previous implementation, which will not be repeated here.

The communication bus 304 mentioned in the above electronic device may be a Peripheral Component Interconnect (PCI) bus or Extended Industry Standard Architecture (EISA) bus, etc. This communication bus 304 may be divided into address bus, data bus, control bus, etc. For convenience of representation, only one thick line is used in the figure for representation, but this does not indicate that there is only one bus or one type of bus.

The communication interface 302 is configured for communication between the above electronic device and other devices.

The processor 301 may be a Central Processing Unit (CPU), and may also be other general processors, Digital Signal Processors (DSP), Application Specific Integrated Circuits (ASIC), Field-Programmable Gate Arrays (FPGA) or other programmable logic devices, discrete gates or transistor logic devices, discrete hardware components, etc. The general processor may be a microprocessor or the processor may also be any conventional processor, etc. The processor 301 is the control center of the electronic device, utilizing various interfaces and lines to connect various parts of the entire electronic device.

The memory 303 may be used to store the computer program, and the processor 301 may realize various functions of the electronic device by running or executing the computer program stored in the memory 303, as well as invoking the data stored in the memory 303.

The memory 303 may include non-volatile and/or volatile memory. Non-volatile memory may include Read-Only Memory (ROM), Programmable ROM (PROM), Electrically Programmable ROM (EPROM), Electrically Erasable Programmable ROM (EEPROM) or flash memory. Volatile memory may include Random Access Memory (RAM) or external high-speed cache memory. As an illustration rather than a limitation, RAM is available in many forms, such as Static RAM (SRAM), Dynamic RAM (DRAM), Synchronous DRAM (SDRAM), Double Data Rate SDRAM (DDRSDRAM), Enhanced SDRAM (ESDRAM), Synchlink DRAM (SLDRAM), Rambus Direct RAM (RDRAM), Direct Rambus Dynamic RAM (DRDRAM), and Rambus Dynamic RAM (RDRAM), etc.

According to another aspect of this disclosure, this disclosure further provides a storage medium, which stores a program. When the program is executed, the following steps are implemented:
obtaining original species distribution data;
determining a map grid scale displaying the species distribution, and acquiring the original species distribution data within the range of each grid;
taking each grid as a central grid, and performing data enhancement on the central grid by using original species distribution data of multiple other grids within a set range around the grid, thereby obtaining a species distribution data aggregation result of each grid.

The computer-readable storage medium in an embodiment of the present disclosure may adopt any combination of one or more computer-readable media. The computer-readable medium may be a computer-readable signal medium or a computer-readable storage medium. The computer-readable storage medium may be, but is not limited to, an electric, magnetic, optical, electromagnetic, infrared, or semiconductor system, apparatus, or device, or any combination thereof. More specific examples (a non-exhaustive list) of the computer-readable storage medium include: an electrical connection having one or more wires, a portable computer hard disk, a hard disk, Random Access Memory (RAM), Read-Only Memory (ROM), Erasable Programmable Read-Only Memory (EPROM or flash memory), an optical fiber, a portable compact disc read-only memory (CD-ROM), an optical storage device, a magnetic storage device, or any suitable combination of the above. In this context, a computer-readable storage medium may be any tangible medium that contains or stores a program, which may be used by or in combination with an instruction execution system, apparatus, or device.

The computer-readable signal medium may include a data signal propagating in a baseband or as part of a carrier wave, which carries computer-readable program code. This propagated data signal may take various forms, including but not limited to electromagnetic signals, optical signals, or any suitable combination thereof. The computer-readable signal medium may also be any computer-readable medium other than a computer-readable storage medium, which may send, propagate, or transmit a program for use by or in conjunction with an instruction execution system, apparatus, or device.

The computer program code for performing the operations of this disclosure may be written in one or more programming languages or a combination thereof, including object-oriented programming languages such as Java, Smalltalk, C++, as well as conventional procedural programming languages such as the “C” language or similar programming languages. The program code may be executed entirely on the user's computer, partly on the user's computer, as a stand-alone software package, partly on the user's computer and partly on a remote computer, or entirely on a remote computer or server. In the case involving a remote computer, the remote computer may be connected to the user's computer through any type of network, including a Local Region Network (LAN) or a Wide Region Network (WAN), or may be connected to an external computer (for example, through the Internet using an Internet Service Provider).

It should be noted that the apparatus and method disclosed in the implementations of this disclosure may also be realized through other ways. The implementations of the described apparatus are merely illustrative. For example, the flowcharts and block diagrams in the drawings show possible implementations of the architecture, functions, and operations of apparatus, methods, and computer program products according to multiple implementations of this application. In this regard, each block in the flowcharts or block diagrams may represent a module, program segment, or part of code, which contains one or more executable instructions for implementing the specified logical function(s). The module, program segment, or part of code contains one or more executable instructions for implementing the specified logical function(s). It should also be noted that, in some alternative implementations, the functions noted in the blocks may occur in a different order than that noted in the drawings. For example, two consecutive blocks may be actually executed substantially in parallel, and they may be sometimes executed in the reverse order, depending on the functionality involved. It should also be noted that each block of the block diagrams and/or flowcharts, and combinations of blocks in the block diagrams and/or flowcharts, may be implemented by special purpose hardware-based systems that perform the specified functions or actions, or combinations of special purpose hardware and computer instructions.

In addition, the various functional modules in each implementation of this disclosure may be integrated together to form an independent part, or may exist separately as individual modules, or two or more modules may be integrated to form an independent part.

The above description is only a description of the preferable implementations of this disclosure, and is not any limitation on the scope of this disclosure. Any changes or modifications made by ordinary skilled persons in the art of this disclosure based on the above disclosed content are within the scope to be protected by the claims.

1. A species distribution data aggregation method, characterized in comprising the following steps:
obtaining original species distribution data;
determining a map grid scale displaying a species distribution, and acquiring the original species distribution data within a range of each grid; and
taking each grid as a central grid, and performing data enhancement on the central grid by using the original species distribution data of a plurality of other grids within a set range around each grid, thereby obtaining a species distribution data aggregation result of each of the grid.

2. The species distribution data aggregation method according to claim 1, wherein the original species distribution data is obtained through a species distribution data source and species identification result information.

3. The species distribution data aggregation method according to claim 2, wherein obtaining the original species distribution data through the species identification result information comprises: obtaining user wireless data or mobile data for processing to obtain the original species distribution data.

4. The species distribution data aggregation method according to claim 1, wherein the method further comprises: after obtaining the original species distribution data within the range of each grid, processing the original species distribution data according to species commonness to obtain processed species distribution data, and utilizing the processed species distribution data for subsequent data enhancement.

5. The species distribution data aggregation method according to claim 1, wherein the method further comprises: obtaining an elevation value for each grid, calculating an elevation difference between each of the central grid and the plurality of other grids within the set range around each grid, wherein when the elevation difference between any one of the plurality of other grids and the central grid thereof is greater than a set threshold, the original species distribution data of the plurality of other grids do not involve in the data enhancement of the central grid.

6. The species distribution data aggregation method according to claim 5, wherein the set threshold of the elevation difference is separately set and adjusted according to different regions.

7. The species distribution data aggregation method according to claim 1, wherein the map grid scale is separately set and adjusted according to different regions and/or different map grid scales are set for a same region.

8. The species distribution data aggregation method according to claim 1, wherein the data enhancement comprises: obtaining a weight value for each of the other grids within the set range around the central grid according to a set attenuation coefficient, multiplying the original species distribution data of the other grids by the weight value and added to data of the central grid, thus finally obtaining the species distribution data aggregation result after the data enhancement for the central grid.

9. The species distribution data aggregation method according to claim 8, wherein the attenuation coefficient is separately set and adjusted according to different regions.

10. The species distribution data aggregation method according to claim 1, wherein the method further comprises: classifying the original species distribution data according to a time dimension, obtaining the original species distribution data within the range of each grid at different times, and performing the data enhancement separately based on the original species distribution data at the different times.

11. A species distribution data aggregation system, characterized in comprising a processor and a memory, wherein the memory stores a program, and when the program is executed by the processor, the species distribution data aggregation method according to claim 1 is realized.

12. A non-transitory computer readable storage medium, which stores a program and is characterized in that when the program is executed, the species distribution data aggregation method according to claim 1 is realized.
